(19) United States
(12) Patent Application Publication
(10) Pub. No.: US 2015/0095334 A1
(43) Pub. Date: Apr. 2, 2015

(54) DATA ANALYSIS SUPPORT SYSTEM

(71) Applicant: HITACHI, LTD., Tokyo (JP)

(72) Inventors: Satomi TSUJI, Tokyo (JP); Kazuo YANO, Tokyo (JP); Nobuo SATO, Tokyo (JP)

(21) Appl. No.: 14/482,055

(22) Filed: Sep. 10, 2014

(30) Foreign Application Priority Data
Sep. 17, 2013 (JP) 2013-191637

(51) Int. Cl. G06F 17/30

(52) U.S. Cl. CPC G06F 17/30705; G06F 17/30619
USPC 707/737

(57) ABSTRACT

A data analysis support systems according to the present invention assumes any of multiple indices to be an objective variable, implements clustering and collectively outputs indices belonging to the identical cluster.

### CROSS-REFERENCE TO RELATED APPLICATIONS

This application claims the priority of Japanese Patent Application No. 2013-191637, filed on Sep. 17, 2013, which is incorporated herein by reference in its entirety.

### BACKGROUND OF THE INVENTION

1. Field of the Invention

The present invention relates to a technology that supports the analysis of electronic data.

2. Description of the Related Art

As an information-communication technology develops and a large amount of data related to business management is electronically accumulated, regarding the use of these, there is demanded a technique that can easily lead a measure with a management effect even by others than analysis specialists. To do so, there is required a technique that selects an index with high utility from many indices used when data is analyzed.

Regarding a technology that processes a large amount of data, JP-2011-141801-A and U.S. Pat. No. 8,392,408 describe a technique that finds page candidates to be focused on by the user from a huge Web page group. In these literatures, the Web page group is subjected to clustering on the basis of the frequency of keywords beforehand, and, when the user inputs a specific keyword, a list of web pages related thereto is generated.

### SUMMARY OF THE INVENTION

If the amount or format of electronic data is diversified, indices used when this is analyzed are diversified too, and various choices are considered. It is difficult for a data analyst to understand all of these indices, and it is considered that many indices that are not necessarily useful to acquire a desired analysis result are included. Then, there is demanded a technique that appropriately selects an analysis index by which it is possible to effectively acquire a data analysis result expected by the data analyst when the data analysis is implemented.

In JP-2011-141801-A and U.S. Pat. No. 8,392,408, it is considered that some analysis index is used when web pages are subjected to clustering beforehand, but they do not disclose a technique that effectively selects an analysis index by which a data analyst can acquire a desired effect.

The present invention is made in view of the above-mentioned problem, and it is an object to provide a technology that supports effective selection of an index used when data is analyzed.

A data analysis support system according to the present invention assumes one of multiple indices as an objective variable, implements clustering and collectively outputs indices belonging to the identical cluster.

According to a data analysis support system according to the present invention, it is possible to effectively select an index having a statistical relation with a target index to be improved.

### BRIEF DESCRIPTION OF THE DRAWINGS

FIG. 1 is a schematic configuration diagram of a data analysis support system according to a first embodiment;

FIG. 2 is a diagram illustrating a detailed configuration of a data analysis support system;

FIG. 3 is a processing sequence diagram of the data analysis support system according to the first embodiment;

FIG. 4 is a flowchart that describes processing in an analysis server (AS) when a client (CL) downloads an index;

FIG. 5 is a flowchart that describes the operation of a hierarchical clustering unit (ASCC);

FIG. 6 is a flowchart that describes the operation of an index selection managing unit (ASCIM);

FIG. 7 is one example of screen display displayed on a display (CLOD) through screen drawing (CLCD) of a client (CL);

FIG. 8A is an example of an index correlation diagram which a client (CL) displays when a clustering display switching button (CDB2) is pressed;

FIG. 8B is an example of hierarchically displaying the same index correlation diagram as FIG. 8A;

FIG. 9A is a diagram illustrating a configuration of an index table stored in an index database (ASMD) and a data example;

FIG. 9B is a diagram illustrating a configuration of an index table and a data example in a case where the time is assumed to be a key (Kb1); and

FIG. 10 is a diagram illustrating a configuration of an index selection list (ASMI) and a data example.

### DESCRIPTION OF THE PREFERRED EMBODIMENTS

In the following, as embodiments of the present invention, a data analysis support system that supports the selection of an index used when a large amount of electronic data is analyzed is described. The present system specifies any one of multiple indices as an objective variable (an index to be improved, for example, “store sales on holidays”, and so on) and implements hierarchical clustering with respect to the other indices based on the objective variable. It is considered that indices included in the identical cluster are an index group having correlation with the objective variable. By collectively outputting the indices included in this identical cluster, it is possible to effectively select an index predicted to be able to improve the objective variable. In the following, specific examples of the present system are described.

### First Embodiment: Outline of Data Analysis Support System

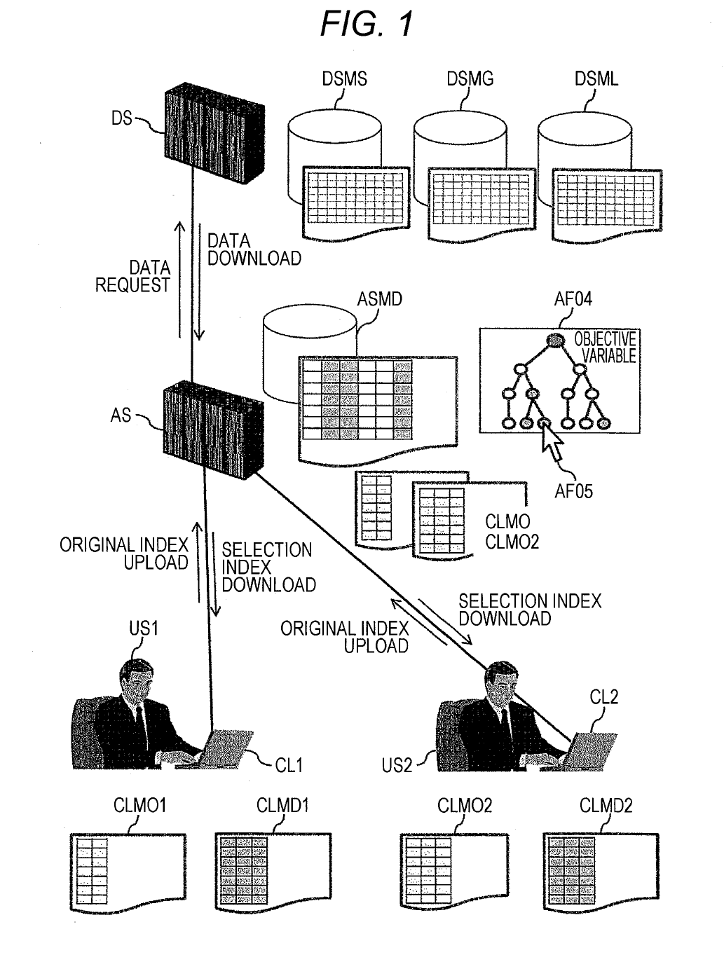

FIG. 1 is a schematic configuration diagram of the data analysis support system according to the first embodiment of the present invention. The present system includes a data server (DS), an analysis server (AS) and a client (CL).

The data server (DS) denotes a server that stores various kinds of electronic data that is the basis of data analysis. For example, the data server (DS) includes, a sensor database (DSMS), a business database (DSMG) and an operation status log database (DSML), and so on. The sensor database (DSMS) stores sensor data acquired from a wearable (attachable to the body) sensor terminal of the name tag type or the wristwatch type. The business database (DSMG) stores sales information, employee attendance information and company account information, and so on, which are acquired by a POS (Point Of Sales) system. The operation status log database (DSML) stores a result of periodically monitoring the operation status of factory or plant equipment.

The data server (DS) can also hold data other than those mentioned above. The stored data may not be limited to a numerical value and may be digital data in the form of a text, voice, image or animation, or may be data of a position, acceleration or operation log acquired by a smartphone. Each database may be stored on respective data servers (DS) according to the data kind and connected with the analysis server (AS) by a network.

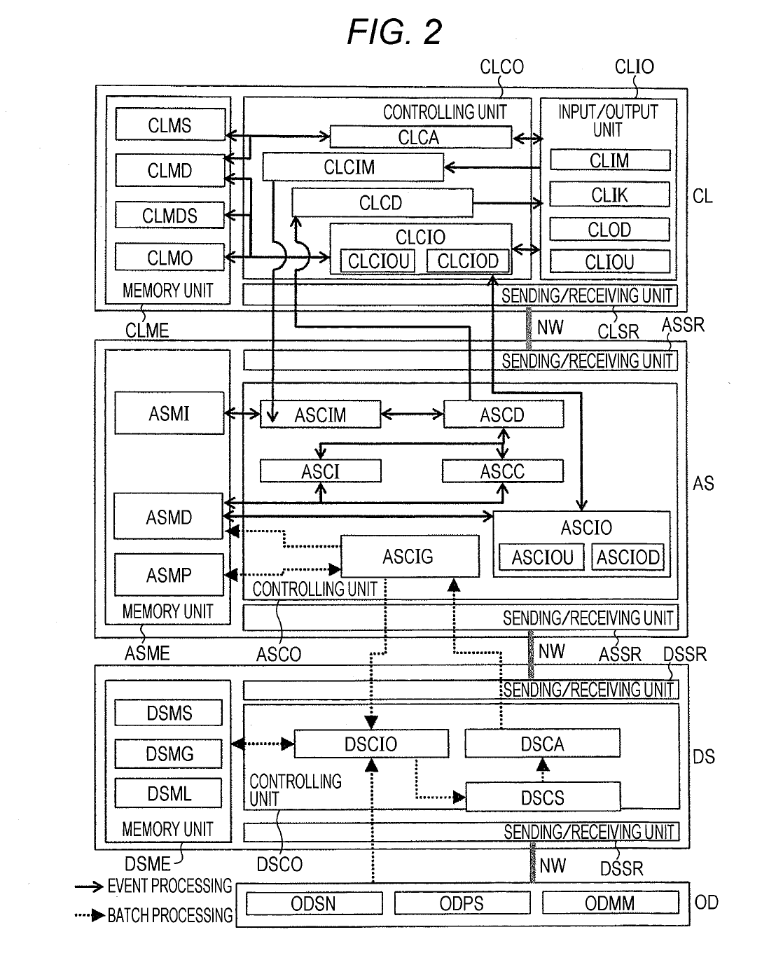

The analysis server (AS) denotes a server that generates an index used when the data stored in the data server (DS) is analyzed. The analysis server (AS) issues a data request to the data server (DS), downloads necessary data from the data server (DS) and generates multiple kinds of indices by an index generation program (ASMP described later in FIG. 2). At this time, different kinds of data of the data server (DS) may be mutually linked on the basis of time information or user ID information to generate a new index. For example, purchase information acquired from the POS system and position information acquired from a name-tag-type terminal are linked by the time information and the user ID information. By this means, it is possible to generate an index related to a commodity whose commodity shelf is passed and which is not purchased.

The indices generated by the analysis server (AS) are summarized in a table form of N kinds (number of indices)×M lines (sampling data number of each index) and stored in an index database (ASND). Each index can be classified by the character of a key column and the classified indices can be stored as respective tables. As the kind of the key column, for example, the user ID, the place ID and time information, and so on, are considered. In addition, in the case of the time information, it is possible to handle it as an index of a different kind according to the sampling interval thereof. When the user (US) downloads an index from the analysis server (AS), the user (US) is caused to designate what kind of a table is downloaded.

The client (CL) denotes a terminal which the user directly operates. Specifically, it is a PC, tablet or smartphone having an interface such as a screen and a keyboard. The user (US) denotes a data analyst who selects an index, implements data analysis by the use of the index and interprets the analysis result. The procedure of analysis execution is as follows.

The user (US) uploads an original index (CLMO) used when oneself implements the data analysis, from the client (CL) to the analysis server (AS). The analysis server (AS) merges the index in the index database (ASMD) and the original index (CLMO), implements hierarchical clustering to the indices according to an objective variable (for example, the value of sales or profit) designated by the user (US), and illustrates the hierarchical relationship between the indices acquired as a result thereof (AF04). The user (US) selects an index to be checked more in detail (an index that seems to be effective to improve the objective variable) on the hierarchical relationship diagram. When the user (US) selects one index, a lower-hierarchy index belonging to the identical cluster is automatically selected too. Since indices having a similar characteristic are classified into the identical cluster by hierarchical clustering, it is possible to collectively select associated indices and contribute to the shortening of the analysis time. The user (US) repeats this index selection procedure several times, and, when the selection is completed, notifies the information to the analysis server (AS). The analysis server (AS) outputs the index selected by the user (US) and sampling data of the index.

The user (CL) analyzes data in detail on the client (CL) by the use of a downloaded index (CLMD). For example, it is possible to perform operation of drawing a distribution diagram to confirm an outlier, installing analysis software in the client to try a new analysis technique and creating a graph to make a report, and so on. Moreover, a new index generated by deleting the outlier from the downloaded index (CLMD) or mutually combining indices can be uploaded to the analysis server (AS) as a new original index (CLMO) and the analysis can be implemented again.

Multiple users (US) and clients (CL) may exist with respect to one analysis server (AS). Each user (US) may upload each original index (CLMO) to the analysis server (AS) to combine it with the index database (ASMD), and allow other users to share the index. By doing so, it is possible to analyze large-scale data by multiple users in cooperation with each other and to facilitate work division and knowledge sharing.

The analysis server (AS) shared by multiple users has low flexibility and has difficulty in introducing new analysis software from the viewpoint of management and operation, but, by running data on the client (CL), it is possible to flexibly try new software and analysis technique on a PC managed by the individual. In addition, since it is possible for the analysis server (AS) to select only an index that seems to be useful and download it to the client (CL), each user does not have to introduce an expensive high-spec computer and it is possible to implement necessary analysis in a cheap low-spec PC. By causing the analysis server (AS) and the data server (DS) to mount large capacity storage and a high-speed CPU and further become accessible from multiple users, they can be provided as a cloud service. Moreover, it is possible to virtualize part of the analysis server (AS) without separating the client (CL) as an independent terminal from the analysis server (AS) and use a virtual region as the client (CL) which can be independently utilized by multiple users.

In a case where the system illustrated in FIG. 1 is mounted on one computer, a function implemented by the client (CL) in FIG. 1 can be implemented on a memory and a function implemented by the analysis server (AS) can be implemented on storage. By this means, it is possible to select only a useful index from large-scale data on the storage, output it onto the memory and implement more detailed analysis at high speed on the memory. The memory has a higher price per data capacity than the storage, but the price and the speed can be both satisfied by the above-mentioned configuration.

### Detailed Configuration of Data Analysis Support System

FIG. 2 is a diagram illustrating a detailed configuration of a data analysis support system. A solid line arrow shows a flow (event processing) of an order or data started at the timing at which the order is received from the user (US). A dotted line arrow shows a flow (batch processing) of an order or data executed automatically and periodically at the time designated by a timer (not illustrated) beforehand. In the following, the configuration of each device is described.

### Data Server (DS) and External Device (OD)

The data server (DS) connects with the external device (OD) through a sending/receiving unit (DSSR) and stores data acquired by those devices in a memory unit (DSME). A mode of sending data from the external device (OD) to the data server (DS) may be possible through a network (NW), or the data acquired by the external device (OD) may be stored in a memory medium (not illustrated) such as a CD-R and a USB memory, and may be manually transferred. The external device (OD) denotes, for example, a device such as a sensor terminal (ODSN), a POS system (ODPS) and an equipment monitoring system (ODMM). The sensor terminal (ODSN) denotes a wearable sensor terminal of the name tag type or the wristwatch type. The POS system (ODPS) acquires sales information of a cash register. The equipment monitoring system (ODMM) periodically monitors the operation status of factory or plant equipment.

The data server (DS) includes a sending/receiving unit (DSSR), a memory unit (DSME) and a controlling unit (DSCO).

The sending/receiving unit (DSSR) sends/receives data or an order to/from other devices connected with the network (NW) such as the external device (OD) and the analysis server (AS), and implements communication control at that time.

The memory unit (DSME) is configured with a data memory device such as a hard disk, and stores data acquired from the external device and a program to manage the input/output and backup of data, and so on. For example, a database may be used to store the data, and, for each external device of a data source, it may be separately stored in, for example, the sensor database (DSMS), the business database (DSMG) and the operation status log database (DSML). Data acquired from multiple external devices may be combined using time information or user information here as a key and stored in one database.

The controlling unit (DSCO) includes a CPU (illustration is omitted) and controls the sending/receiving of data and the input/output with a database. Specifically, when the CPU executes a program (not illustrated) stored in the memory unit (DSME), the operation of a data input/output managing unit (DSCIO), data collating (DSCS) unit and data matching (DSCA) unit is realized. These function units can be configured by hardware such as a circuit device that realizes similar functions. The same applies to other function units described below.

The data input/output managing unit (DSCIO) retrieves data in the memory unit (DSME) when data is requested from the analysis server (AS), and outputs what matches the request in an appropriate form.

The data collating unit (DSCS) mutually links different kinds of data extracted in response to the request from the analysis server (AS), using the user ID, the time information or the position information as a key.

The data matching unit (DSCA) adjusts the data integrity by making the time information of the different kinds of data uniform. For example, in a case where the sampling interval is one minute on the equipment monitoring system (ODMM) but the sampling interval is one second on the wearable sensor terminal (ODSN), it is adjusted to the sparse sampling interval. In a case where time synchronization is not performed between external devices (OD), the time information of data is corrected, and, in a case where a clear outlier exists, it is deleted.

For example, data subjected to data collation (DSCS) and data matching (DSCA) is output in a numeric-type table format to the analysis server (AS) through the sending/receiving unit (DSSR). Information on original data (such as a form, a sampling interval and a unit) acquired by the external device (OD) may be output together. By experiencing the data collation (DSCS) and the data matching (DSCA), the integrity of data acquired from different kinds of devices is secured. Therefore, the analysis server (AS) can perform index generation and analysis without considering the difference between the characteristic of each data.

### Analysis Server (AS)

The analysis server (AS) denotes a server that processes data received from the data server (DS), generates and stores an index, uses the index to perform basic analysis such as statistical analysis and visualization, and supports the user to select the index by generating an image, and so on.

The analysis server (AS) includes a sending/receiving unit (ASSR), a memory unit (ASME) and a controlling unit (ASCO).

The sending/receiving unit (ASSR) sends/receives data and order to/from other devices connected with the network (NW) such as the data server (DS) and the client (CL), and implements communication control at that time.

The memory unit (ASME) is configured with a memory device such as a hard disk, a memory and an SD card. The memory unit (ASME) stores information required for index generation/selection and a generated index. Specifically, the memory unit (ASME) stores an index generation program (ASMP), an index database (ASMD) and an index selection list (ASMI).

The index generation program (ASMP) denotes a program that describes the kind of data acquired from the data server (DS) and a procedure to process it and generate each index. Detailed operation of the index generation program (ASMP) is described later.

The index database (ASMD) denotes a database that stores the index generated by the index generation program (ASMP). The index database (ASMD) stores multiple kinds of indices in, for example, a table format, using the time, the user ID or position information as a key.

The index selection list (ASMI) denotes a list to sequentially memorize a selected index and an unselected index in a process that selects an index to be downloaded while the user (US) looks at a hierarchical clustering (ASCC) result displayed on the screen of the client (CL).

The controlling unit (ASCO) includes a CPU (illustration is omitted), and implements data processing for index generation, basic analysis (for example, statistical analysis and visualization) using an index, and image generation to select an index by the user, and so on. Specifically, when the CPU executes a program (not illustrated) stored in the memory unit (ASME), the operation of an index generating unit (ASCIG), index input/output unit (ASCIO), hierarchical clustering unit (ASCC), index correlation calculating unit (ASCI), screen drawing unit (ASCD) and index selection managing unit (ASCIM) is realized. Other analysis techniques can be executed by storing a statistical analysis program or application in the memory unit (ASME) and executing it.

The index generating unit (ASCIG) executes index generation at the timing at which a timer is automatically started or a request is made from the user. The index generating unit (ASCIG) requests necessary data to the data input/output managing unit (DSCIO) of the data server (DS) according to processing described in the index generation program (ASMP). When receiving the data from the data server (DS), an index is generated using the data and stored in the index database (ASMD). Multiple kinds of indices may be generated at a time, or the indices may be sequentially generated using respective index generation programs (ASMP) in multiple separate times and stored in the index database (ASMD).

The index input/output unit (ASCIO) manages the input (upload (ASCIOU)) and output (download (ASCIOD)) of an index. At the time of the output, an index request is received from the client (CL), and a corresponding index in the index database (ASND) is output to the client (CL). Alternatively, the index may be output onto a memory that is more high-speed than the memory unit (ASME) or output to a different region virtualized in the analysis server (AS). At the time of the input, the original index (CLMO) sent from the client (CL) is received, the form is adjusted so as to be equally treated with data in the index database (ASMD), and it is stored in the index database (ASMD). This is similar to the output time, and not only an input from the client (CL) but also an input from a memory or a virtual region can be similarly implemented.

The hierarchical clustering unit (ASCC) performs clustering of multiple indices stored in the index database (ASMD). Specifically, for example, indices that have similar features, change in synchronization with each other or have a correlation relationship are associated and identified as the identical cluster. In this specification, a hierarchical clustering method is used as one example of a clustering method. In the hierarchical clustering, indices that correlate to a designated objective variable are extracted in stages, and the relationships between the indices are expressed by a tree network in which the objective variable is a vertex. The screen drawing unit (ASCD) generates an image showing a clustering result, and outputs it to output equipment which the user (US) can view, such as the display (CLOD) in the client (CL). In a case where the client (CL) itself can draw a similar image, only the clustering result may be sent to the client (CL).

The index correlation calculating unit (ASCI) calculates a network diagram showing the relationships between indices. By seeing the network diagram, it becomes easy for the user (US) to make a decision to additionally select or delete an index. Similar to the processing result of the hierarchical clustering unit (ASCC), this calculation result is output to output equipment in the client (CL) through the screen drawing unit (ASCD).

The screen drawing unit (ASCD) generates and displays an image to present the clustering result to the user (US). For example, it is mounted in a form such as a web application and a servlet. Moreover, according to operation performed on the screen by the user, index selection and analysis condition setting are read and reflected as execution conditions of the index input/output unit (ASCIO) and the index selection managing unit (ASCIM).

When the user (US) selects or deselects the index, the index selection managing unit (ASCIM) updates the index selection list (ASMI) according to the operation. In a case where a certain index is selected, other indices belonging to the identical cluster can be automatically selected too. Similarly, in a case where the certain index is deselected, other indices belonging to the identical cluster can be automatically deselected too. In the hierarchical clustering, child indices having a common parent index are assumed to belong to the identical cluster, and, in a case where the parent index is selected or deselected, the child indices can be collectively selected or deselected.

### Client (CL)

The client (CL) denotes equipment having an interface that can be directly operated by the user (US). The client (CL) has a sending/receiving unit (CLSR), a memory unit (CLME), an input/output unit (CLIO) and a controlling unit (CLCD).

The sending/receiving unit (CLSR) sends/receives data and order to/from other equipment connected with the network (NW) such as the analysis server (AS), and implements communication control at that time.

The memory unit (CLME) is configured with a recording device such as a hard disk, a memory and an SD card. The memory unit (CLME) stores an original index table (CLMO), a download index table (CLMD), download index information (CLMDS) and a statistical analysis application (CLMS).

The original index table (CLMO) denotes a table that holds an index which is acquired via a path different from that of data sent from the external device (OD) to the data server (DS) and which the user (US) uniquely owns. The original index (CLMO) merged with an index in the index database (ASMD) or only the original index (CLMO) can be processed by the hierarchical clustering unit (ASCC) or the index correlation calculating unit (ASCI). By performing an upload to the analysis server (AS), it is possible to utilize the function of the analysis server (AS) without installing an analysis program in the client (CL).

Moreover, it is possible to share the original index (CLMO) with other users (US). Furthermore, by processing an index downloaded from the analysis server (AS) and storing it in the original index table (CLMO), it can be utilized as a new index. Examples of the index processing include deleting an outlier or redefining the ratio of two kinds of indices of the identical time as a new index. It is desirable that the form of the original index table (CLMO) matches or has interchangeability with the form of the index database (ASMD), but, otherwise, the index input/output unit (CLCIO or ASCIO) may convert the form.

The download index table (CLMD) denotes a table that stores an index selected and downloaded from the analysis server (AS).

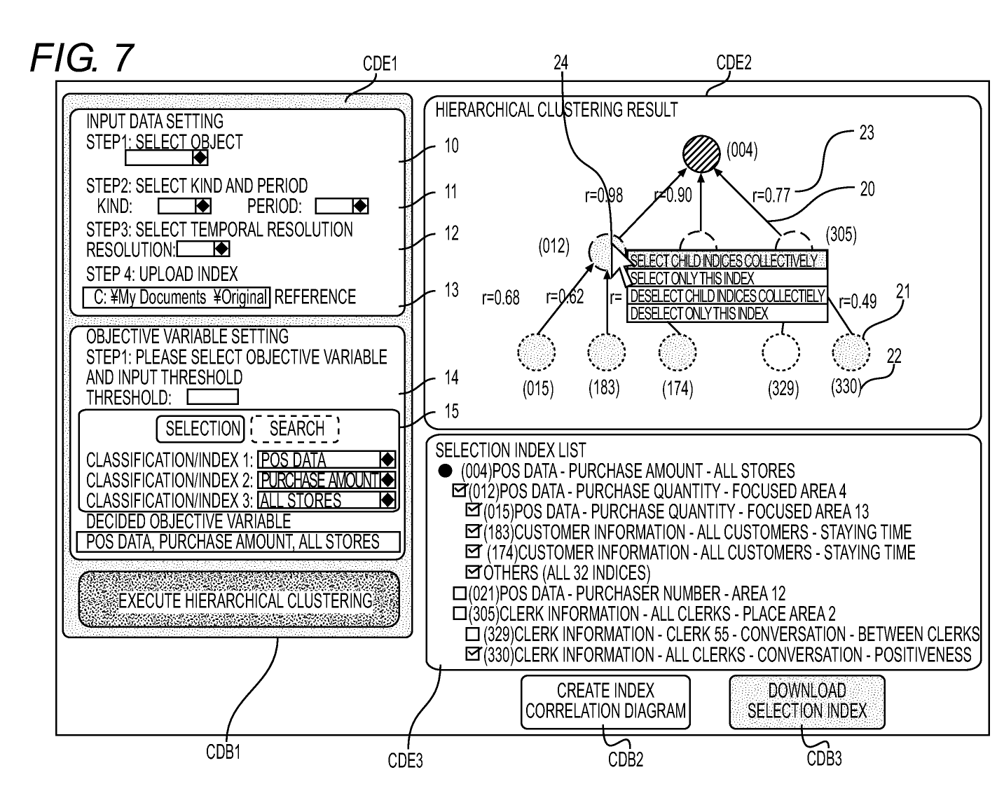

The download index information (CLMDS) is downloaded together with supplementary information of an index when the index is downloaded from the analysis server (AS). For example, the supplementary information denotes information showing a coefficient calculated in a calculation process of the hierarchical clustering unit (ASCC) or the index correlation calculating unit (ASCI) or a result of selecting an index by the user (US). Specifically, it denotes information showing the value of a mutual partial correlation coefficient between downloaded indices or the relationship with an objective variable or parent index when the user (US) selects the index. This corresponds to each parameter and display result shown in a screen example of FIG. 7 described below. The download index information (CLMDS) has meaning as information that the user (US) can reproduce the clustering result and the selection result of each index later. If a similar effect can be produced, the specific content and form of the download index information (CLMDS) do not matter.

The statistical analysis application (CLMS) denotes an application to implement statistical analysis in the client (CL). It may be a commercially available application to be installed or a proprietary program. By using the statistical analysis application (CLMS), since the user (US) can introduce an independent analysis technique separately from the analysis server (AS) in the client (CL), it is possible to improve the degree of freedom and flexibility of analysis.

The memory unit (CLME) may additionally store the history of display and the log-in ID by which the user (US) logs in the analysis server (AS), and so on.

The input/output unit (CLIO) denotes a part that becomes an interface with the user (US). The input/output unit (CLIO) includes a display (CLOD), a keyboard (CLIK) and a mouse (CLIM), and so on. Other input/output devices can be optionally connected with an external input/output unit (CLIO).

The controlling unit (CLCO) includes a CPU (illustration is omitted), and, when the CPU executes a program (not illustrated) stored in the memory unit (ASME), realizes the operation of an index input/output unit (CLCIO), screen drawing unit (CLCD), statistical analysis unit (CLCA) and index selecting unit (CLCIM).

The Index input/output unit (CLCIO) implements index upload (CLCIOU) and download (CLCIOD). The screen drawing unit (CLCD) outputs a screen created by the screen drawing unit (ASCD) of the analysis server (AS) to the display (CLOD). The index selecting unit (CLCIM) reads an operation instruction when the user (US) selects an index, and sends operation instruction content thereof to the analysis server (AS). The statistical analysis unit (CLCA) uses the function of the statistical analysis application (CLMS) and performs statistical processing of an index such as a download index (CLMD).

### System sequence Diagram

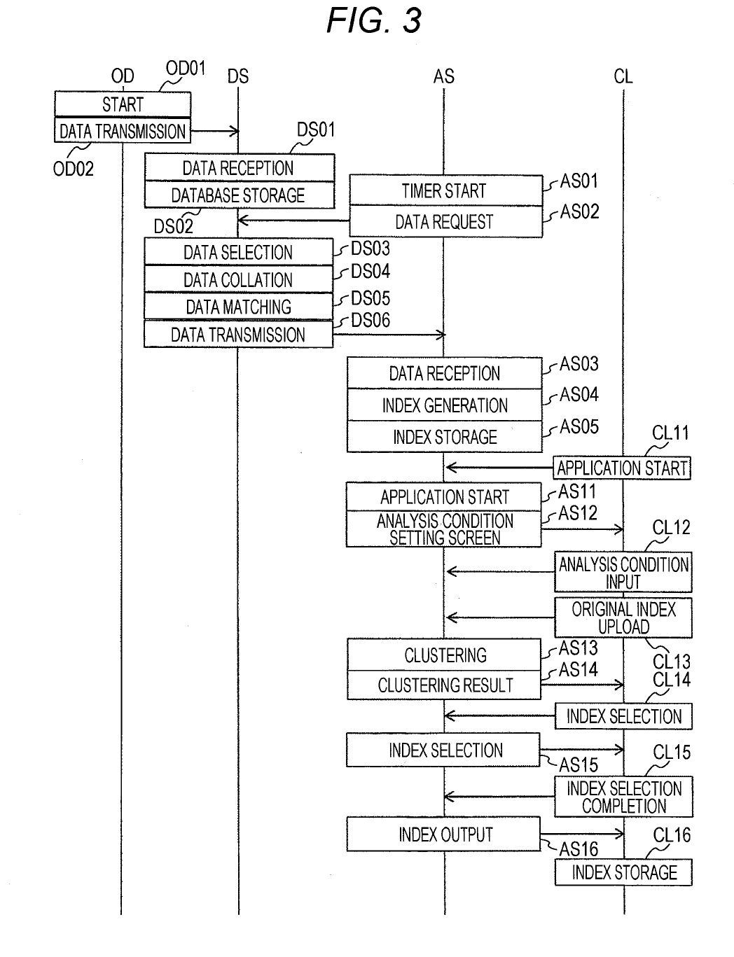

FIG. 3 is a processing sequence diagram of the data analysis support system according to the first embodiment. In the following, each step in FIG. 3 is described.

### System Sequence: Data Acquisition

The external device (OD) sends acquired data to the data server (DS) at the timing at which it is started (OD01) by a timer or in a manual manner (OD02). At this time, the external device (OD) may automatically send the data through the network (NW) or an operator may manually send it by transferring the data to an external memory unit. The data server (DS) receives the data from the external device (OD) (DS01) and stores it in a suitable database in the memory unit (DSME) (DS02).

### System Sequence: Index Generation

The index generating unit (ASCIG) of the analysis server (AS) sends a data request (AS02) to the data input/output managing unit (DSCIO) of the data server (DS) at the timing at which it is started by a timer or in a manual manner (AS01). Specifically, the request is sent while designating the kind and period, and so on, of data required to generate an index. Each function unit of the data server (DS) implements data selection (DS03), data collation (DS04) and data matching (DS05). The data selection (DS03) corresponds to the data input/output managing unit (DSCIO), the data collation (DS04) corresponds to the data collating unit (DSCS) and the data matching (DS05) corresponds to the data matching unit (DSCA) respectively. The sending/receiving unit (DSSR) sends data processed in these function units to the analysis server (AS) (DS06). When the analysis server (AS) receives the data (AS03), the index generating unit (ASCIG) generates an index (AS04) and stores the generated index in the index database (ASMD) (AS05).

### System Sequence: Index Download

The user (US) starts a data analysis support application on the analysis server (AS) through the client (CL) (CL11) (AS11). Here, it is assumed to start a web application on the analysis server (AS) and perform operation from a browser on the client (CL), but an application of the analysis server (AS) may be started by remote control or an application may be started in each of the client (CL) and the analysis server (AS). The analysis server (AS) displays an analysis condition setting screen (AS12). The user (US) inputs an analysis condition by operating the keyboard (CLIK) or the like of the client (CL) (CL12) and notifies it to the analysis server (AS). In a case where it is desired that the original index (CLMO) is uploaded to the analysis server (AS) and analyzed, a file or table of the uploaded index is designated and it is uploaded (CL13).

Taking into account the input analysis condition, the analysis server (AS) performs hierarchical clustering on indices including the uploaded index if any (AS13), and displays the result (AS14). The user (US) selects any index from the clustering result on the screen of the client (CL) (CL14) and the index selecting unit (CLCIM) sends the selection result to the analysis server (AS). The index selection managing unit (ASCIM) of the analysis server (AS) reflects the selection to the index selection list (ASMI) (AS15). When finishing selection of all necessary indices, the user (US) inputs information that the index selection is completed, on the screen (CL15). The analysis server (AS) outputs the indices selected by the user (US) to the client (CL) (AS16). The client (CL) downloads the indices output by the analysis server (AS) and stores them in the download index table (CLMD) (CL16).

### Flowchart of Index Download

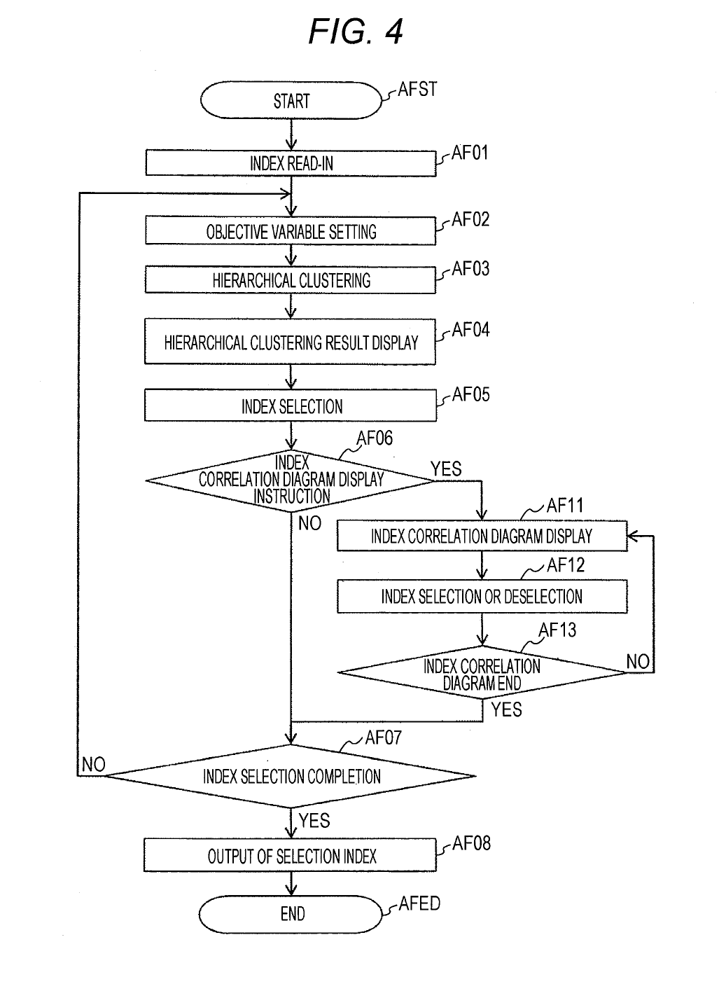

FIG. 4 is a flowchart that describes processing in the analysis server (AS) when the client (CL) downloads an index. This flowchart corresponds to AS11 to AS16 in FIG. 3. In the following, each step in FIG. 4 is described. (FIG. 4: steps AF01 to AF04)

The hierarchical clustering unit (ASCC) reads the index designated in step CL12 from the index database (ASMD) or the original index table (CLMO) (AF01). The hierarchical clustering unit (ASCC) sets the index designated by the user (US) as an objective variable (AF02), performs hierarchical clustering (AS03) and displays the result (AF04).

### (FIG. 4: Steps AF05 to AF08)

The user (US) selects an index included in the clustering result on the screen of the client (CL) (AF05). Steps AF11 to AF13 are implemented in a case where the user (US) gives an instruction so as to display an index correlation diagram on the screen (AF06). The objective variable is optionally changed and it returns to step AF02 to repeat the similar procedure until the user (US) inputs information that the index selection is completed (for example, until a download button described later is pressed) (AF07). When the user (US) inputs the information that the index selection is completed, the index input/output unit (ASCIO) outputs the selected index to the client (CL) (AF08).

### (FIG. 4: Step AF11 to AF13)

The index correlation calculating unit (ASCI) displays a network diagram showing the correlation between multiple indices that are currently selected (AF11). The user (US) further selects or deselects an index on the network diagram (AF12). When the index selection is completed on the network diagram, the user (US) instructs the client (CL) to close the network diagram (AF13). This network diagram is useful in a case where it is desired to select an index while considering the relationships between indices and the correlation between indices as to what kind of measure is executed to acquire an expected effect. An example of the network diagram is described later.

When the user (US) analyzes data including many kinds of indices, it is necessary to obtain permission from not only an analyst who directly operates the data but also a stake-holder (for example, proprietor and manager) who decides a measure to make the best use of the finding acquired from the analysis. To do so, instead of narrowing the most profitable index uniquely, it is desirable to perform trial and error for some indices that are highly likely to relate to the measure, with respect to multiple objective variables. By the procedure illustrated in FIG. 4, it is possible to narrow indices that are highly likely to be profitable while understanding the index characteristics in a multi-sided and phased manner and performing try and error.

### Flowchart of Hierarchical Clustering

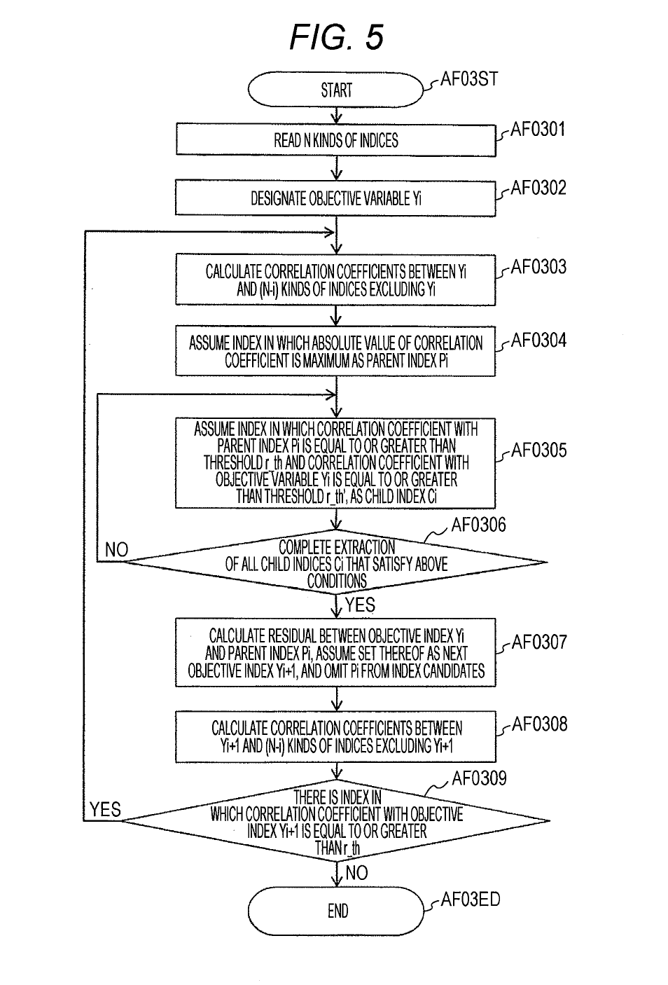

FIG. 5 is a flowchart that describes the operation of the hierarchical clustering unit (ASCC). This flowchart corresponds to step AS13 in FIG. 3 and step AF03 in FIG. 4. The hierarchical clustering denotes processing to support the user (US) to find an index that is highly likely to be profitable from many kinds (described as “N kinds” in FIG. 5) of indices by classifying the indices. The index that is highly likely to be profitable specifically denotes a variable that has correlation with an objective variable and is intervention-possible as a measure. By performing clustering on many kinds of indices, for example, indices that have a similar feature, change in synchronization with each other or have a correlation are associated and identified as the identical cluster. By this means, when indices of the identical cluster are collectively selected at the time of the index selection (step AS15), it is possible to automatically select multiple indices having a similar feature. In the following, the procedure of hierarchical clustering is described on the assumption that each of N kinds of indices has M items of sample value data.

(FIG. 5: steps AF0301 and AF0302)

The hierarchical clustering unit (ASCC) reads N kinds of indices from an index database (ASMID) (AF0301). The hierarchical clustering unit (ASCC) initializes cluster serial number i and assumes an index designated by the user (US) in the analysis condition setting (step CL12) as objective variable Yi (AF0302).

### (FIG. 5: Steps AF0303 and AF0304)

The hierarchical clustering unit (ASCC) calculates correlation coefficients between objective variable Yi and (N-i) kinds of indices excluding Yi (AF0303). The correlation coefficients between the indices in this step denote a correlation function between sampling data of the indices. That is, it is considered that indices whose sampling data has a correlation have a correlation. The hierarchical clustering unit (ASCC) assumes an index in which the correlation coefficient with Yi is maximum (and equal to or greater than preset threshold r_th) among the calculated correlation coefficients as parent index Pi of the i-th cluster (AF0304).

### (FIG. 5: Steps AF0305 and AF0306)

The hierarchical clustering unit (ASCC) calculates correlation coefficients with parent index Pi, with respect to all indices excluding Yi and Pi. An index in which the correlation coefficient with parent index Pi is equal to or greater than threshold r th and a correlation coefficient with objective variable Yi is equal to or greater than preset threshold r_th′, is assumed to be child index Ci of the i-th cluster (AF0305). Here, since parent index Pi is an index in which the correlation coefficient with objective variable Yi is the highest, r_th>r_th′ is established. The hierarchical clustering unit (ASCC) repeats the step until extraction of all child indices Ci that satisfy the condition in step AF0305 is completed (AF0306).

### (FIG. 5: Steps AF0307 to AF0309)

The hierarchical clustering unit (ASCC) calculates a residual between objective variable Yi and parent index Pi, assumes the set of the residual as next objective variable Yi+1 and omit Pi from an index candidate population (AF0307). Next, correlation coefficients between Yi+1 and (N-i) kinds of indices excluding Yi+1 are calculated (AF0308). In a case where there is an index in which the correlation coefficient is equal to or greater than threshold r_th (AF0309), the value of i is increased by 1, and it returns to step AF0303 to repeat similar processing.

At the timing at which there is no index that satisfies the condition in step AF0309, this flowchart ends.

### (FIG. 5: Steps AF0307 to AF0309: Supplementary)

These steps extract an index that has a secondary correlation with objective variable Yi, as the i+1-th cluster. This is realized by assuming the residual between objective index Yi and parent index Pi to be objective variable Yi+1 and excluding parent index Pi from the population.

### Flowchart of Index Selection

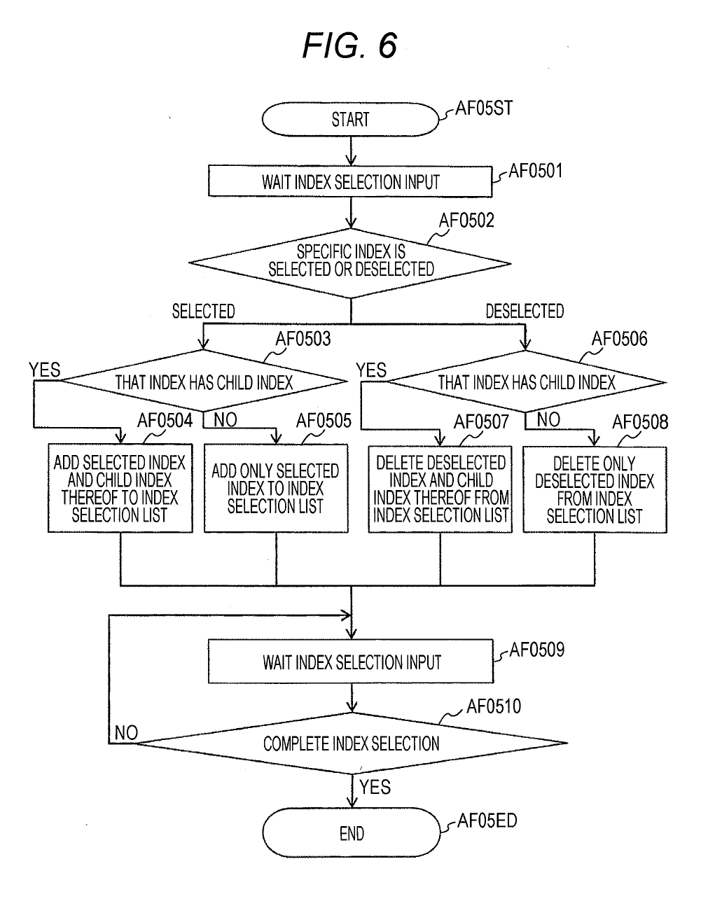

FIG. 6 is a flowchart that describes the operation of the index selection managing unit (ASCIM). This flowchart denotes operation to select an index by the use of a hierarchical clustering result and corresponds to step AS15 in FIG. 3 and step AF05 in FIG. 4. In the following, each step in FIG. 7 is described.

### (FIG. 6: Steps AF0501 and AF0502)

In these steps, a result of hierarchical clustering is displayed on the display (CLOD) of the client (CL). The client (CL) and the index selection managing unit (ASCIM) wait that the user (US) inputs index selection (AF0501)

It proceeds to step AF0503 when a specific index is selected on the display (CLOD), and it proceeds to step AF0506 when it is deselected (AF0502).

### (FIG. 6: Steps AF0503 to AF0505)

The index selection managing unit (ASCIM) receives notification as to which index is selected, from the client (CL), and decides whether the index has a child index in the hierarchical clustering (AF0503). In a case where the selected index has the child index, the selected index and the child index are added to an index select list (AF0504). In a case where it does not have the child index, only the selected index is added to the index select list (AF0505).

### (FIG. 6: Steps AF0506 to AF0508)

The index selection managing unit (ASCIM) receives notification as to which index is deselected, from the client (CL), and decides whether the index has a child index in the hierarchical clustering (AF0506). In a case where the deselected index has the child index, the deselected index and the child index are deleted from the index select list (AF0507). In a case where it does not have the child index, only the deselected index is deleted from the index select list (AF0508).

### (FIG. 6: Steps AF0509 and AF0510)

The client (CL) and the index selection managing unit (ASCIM) stand by until the next index selection is input (AF0509). When information on completion of the index selection is input, this flowchart ends (AF0510).

### (FIG. 6: Steps AF0503 to AF0508: Supplementary)

In a case where a clustering method that is not hierarchical is used, there is no subordinate relationship between a parent index and a child index. Therefore, when one index is selected or deselected, all other indices belonging to the identical cluster are automatically selected or deselected too. By this means, even in a case where the clustering method that is not hierarchical is used, it is possible to use a procedure similar to this flowchart.

### Screen Display Example of Client

FIG. 7 illustrates one example of screen display displayed on the display (CLOD) through the screen drawing (CLCD) of the client (CL). This screen is generated by the screen drawing unit (ASCD) of the analysis server (AS).

This display screen is configured with an analysis condition setting area (CDE1), a clustering display area (CDE2) and a selection index list display area (CDE3).

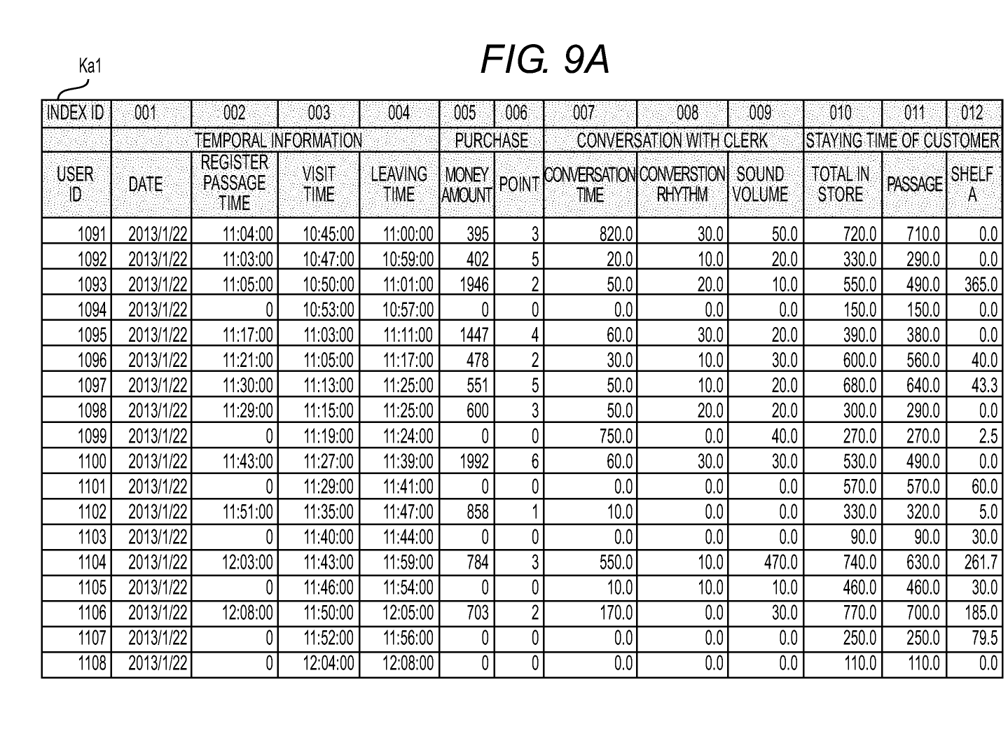

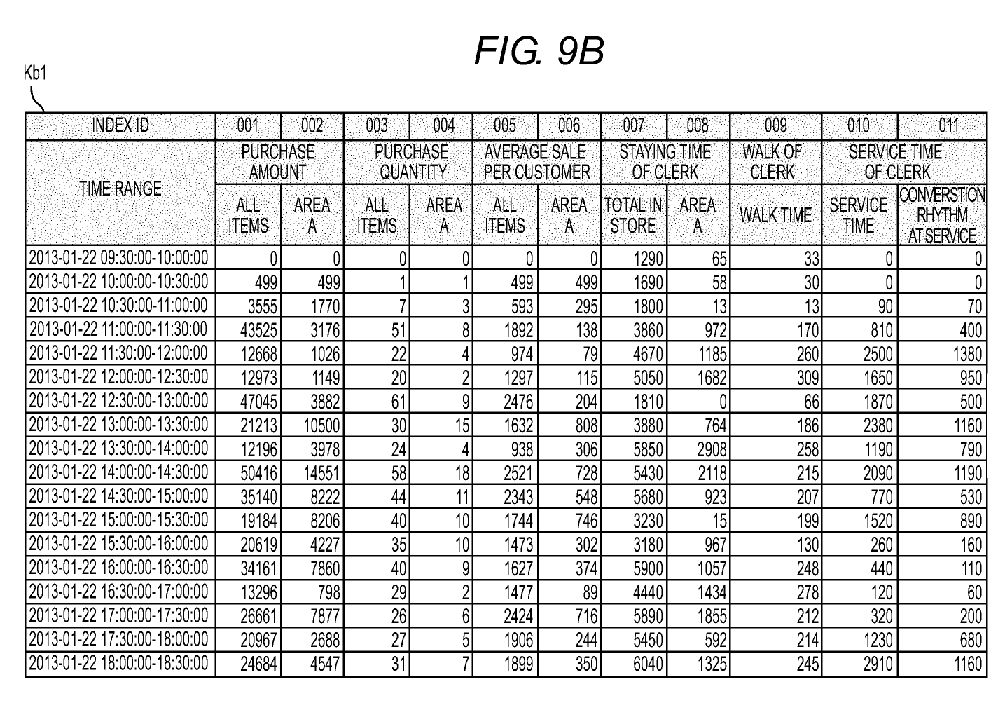

The analysis condition setting area (CDE1) denotes an area in which input data used for analysis is designated and an objective variable at the time of performing hierarchical clustering is set. This corresponds to an interface to implement step CL12 in FIG. 3. The user (US) is caused to designate a store name (10) that is an object of read data, the kind and period of the data (11), and, in a case where “classification by time” is selected as the data kind, temporal resolution thereof (12). The temporal resolution is described again in FIG. 9 described below. In addition, a data file of the original index (CLMO) in the client (CL) is optionally designated and uploaded (13). In addition, the user (US) is caused to designate objective variable (15) and threshold r_th (14) to perform hierarchical clustering. When the input data and the objective variable are set and an analysis execution button (CDB1) is pressed, the hierarchical clustering unit (ASCC) performs hierarchical clustering (AS13) and displays the result on the clustering display area (CDE2) (AS14).

The clustering display area (CDE2) denotes an area in which an analysis result is illustrated, and displays a result of the hierarchical clustering and an index correlation diagram. The screen display switching is implemented by a clustering display switching button (CDB2). FIG. 7 illustrates a screen in which the hierarchical clustering result is displayed. As a result of executing the flowchart described in FIG. 5, the objective variable is assumed to be most significant, parent index Pi of the i-th cluster below the objective variable and child index Ci of the i-th cluster below parent index Pi are linked by a line (20) and hierarchically displayed. One circle sign (21) indicates one kind of an index and thereby simply indicates the relationships between indices (whether they belong to the identical cluster). The index name and the index ID may be optionally described together (22), and value (23) of a correlation coefficient or partial correlation coefficient between indices may be described together with the line (20) connecting the indices. All of these are supplementary information (download index information (CLMDS)) for the user (US) to select an index. In order to select an index on this screen, for example, a cursor (24) of the mouse (CLIM) is moved to the index and it is clicked. When the index is clicked in a state where it is already selected, the index is deselected. At that time, according to the flowchart in FIG. 6, in a case where the selected or deselected index has a child index, the child index is selected or deselected too. Instead of collectively selecting or deselecting indices, it is possible to individually select or deselect indices. In this case, for example, a selection box is displayed next to the cursor as illustrated in FIG. 7 and behavior is selected by the mouse (CLIM).

The selection index list display area (CDE3) denotes a region in which whether an index is in a currently selected state or it is in a non-selected state is shown in a list form. The display in this area is updated in synchronization with an index selected or deselected on the clustering display area (CDE2). The index selection or deselection can be implemented in these both areas. Whether the index is in the selected state or in the non-selected state is notified to the analysis server (AS) and reflected to the index selection list (ASMI).

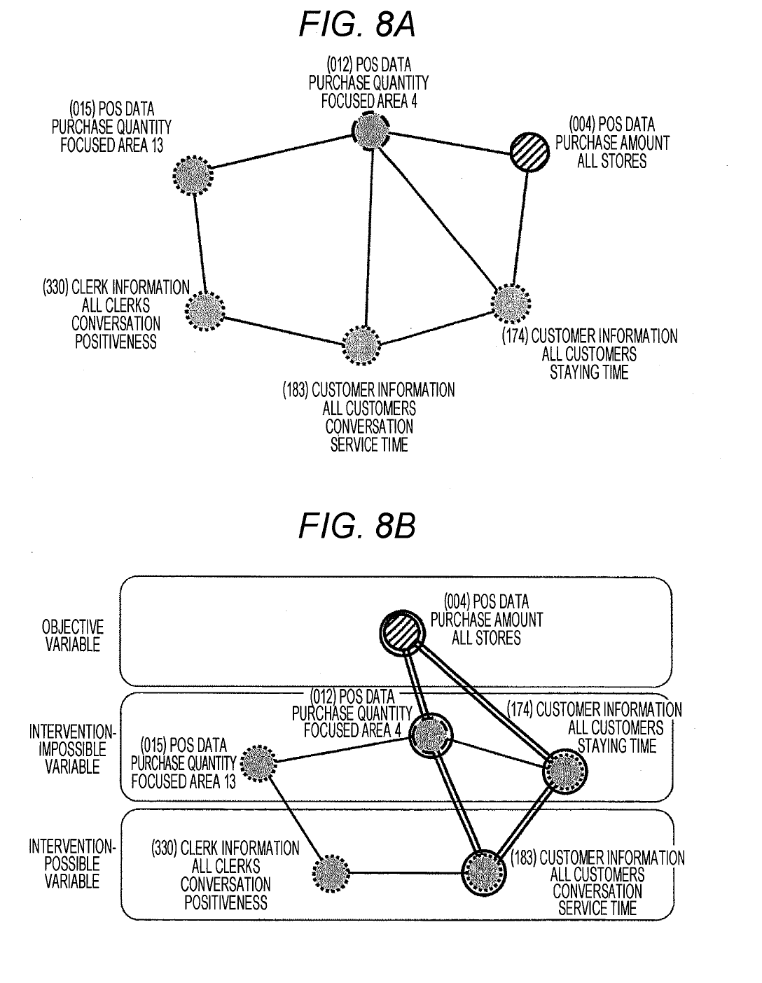

When an index correlation diagram creation button (CDB2) is pressed, the display of the clustering display area (CDE2) is switched between the hierarchical clustering result illustrated in FIG. 7 and the index correlation diagram illustrated in FIG. 8 described below. It is possible to select or deselect an index in either screen.

When a download execution button (CDB3) is pressed, it is regarded that index selection is completed (CL15) (AF0510) (AF07), and data of indices that are selected at that timing is output from the analysis server (AS) to the client (CL).

### Example of Index Correlation Diagram

FIG. 8A is an example of an index correlation diagram displayed by the client (CL) when the clustering display switching button (CDB2) is pressed. The index correlation diagram illustrates the relationships between indices in a selection state. The index correlation diagram is created on the basis of a partial correlation coefficient between indices, and expresses a network by drawing a line between the indices and coupling them in a case where the partial correlation coefficient is equal to or greater than a threshold given in advance. In FIG. 8A, for example, a technique of a spring model or the like is used, and indices linked by the line are closely disposed.

FIG. 8B is an example of hierarchically displaying the same index correlation diagram as FIG. 8A and disposes indices in different hierarchies according to the characteristics of the indices. For example, an objective variable is disposed in the highest hierarchy, an intervention-impossible variable is disposed in the intermediate hierarchy and an intervention-possible variable is disposed in the lowest hierarchy. “Intervention-possible/intervention-impossible” means whether it is possible to implement a direct measure to increase or decrease the index value. For example, for the store manager of a retail store, employee's behavior can be changed by an order and therefore it can be said that employee's behavior is intervention-possible, but what a customer purchases cannot be directly ordered and therefore it can be said that this is intervention-impossible. For example, whether each index is intervention-possible may be defined beforehand in the index selection list (ASMI) or may be subjectively determined and manually decided by the user (US). By performing hierarchical display as illustrated in FIG. 8B, in a case where a measure to increase an intervention-possible index in the lowest hierarchy is executed, how the measure influences other indices and how much influence the measure gives to the objective variable can be confirmed by tracing the link. In FIG. 8B, as one example of display for that, indices influenced in a case where an index ID (183) is intervened in are traced and displayed by a double line. Thus, a path from the intervention-possible variable to the objective variable may be emphatically displayed. This path may be calculated by the index correlation calculating unit (ASCI) and output to the client (CL) or may be calculated by the client (CL).

### Example of Index Database (ASMD)

FIG. 9A is a diagram illustrating a configuration of an index table stored in the index database (ASMD) and a data example. Data generated by index generation (ASCIG) is separately stored in multiple kinds of tables according to a key. As an example of the key, it is possible to use the user or a constant time interval. When a column is assumed to be an index in the table of the database, one record corresponds to one user in a case where the user is assumed to be a key. In FIG. 9A, the user ID (for example, the ID of a sensor terminal attached to a customer) is assumed to be a key (Ka1). This records an index of the behavioral characteristic of one user in one record.

FIG. 9B is a diagram illustrating a configuration of an index table and a data example in a case where the time is assumed to be a key (Kb1). In a case where the time is assumed to be a key, one record corresponds to a constant time width. Here, an example case is shown where the temporal resolution is assumed to be 30 minutes. In a case where the temporal resolution is 30 minutes, for example, the total value of sampling data from 10:00 to 10:30 becomes one record. This shows that the behavior of all customers and all clerks in the time zone is recorded in one record as an index. The index database (ASMD) can additionally store a table with, for example, position information as a key. Furthermore, it is possible to create multiple kinds of tables for respective temporal resolutions. In that case, the user can select a desired temporal resolution in an input column (12) in FIG. 7.

In the tables in FIGS. 9A and 9B, each one vertical column corresponds to one kind of an index. In step AS16 in FIG. 3, a column corresponding to the index selected in step AS15 is picked up, and each record of the column is output. That is, the index database (ASMD) is a table of N columns×M records, and, in a case where n kinds of indices are selected therefrom, the download index table (CLMD) is output as table format data of n kinds×M rows.

Supplementary information for an index such as the index name and the index ID, and so on, may be described in the table or may be described in the download index information (CLMDS). In this case, the object period of output data conforms to a period designated in an input column (11) of the analysis condition setting area (CDE1). When the original index (CLMO) is uploaded (CL13), data that is manually conformed to the form of the index database (ASMD) by the user (US) in the client (CL) may be uploaded, or the form of data that does not conform to that form may be converted by the index input/output unit (ASCIO). The uploaded index may be combined with the table of the index database (ASMD) or may be treated as another table. In the uploaded index and each index in the index database (ASMD), by sharing the form of a key index, it is possible to perform statistical analysis using both data.

### Example of Index Selection List (ASMI)

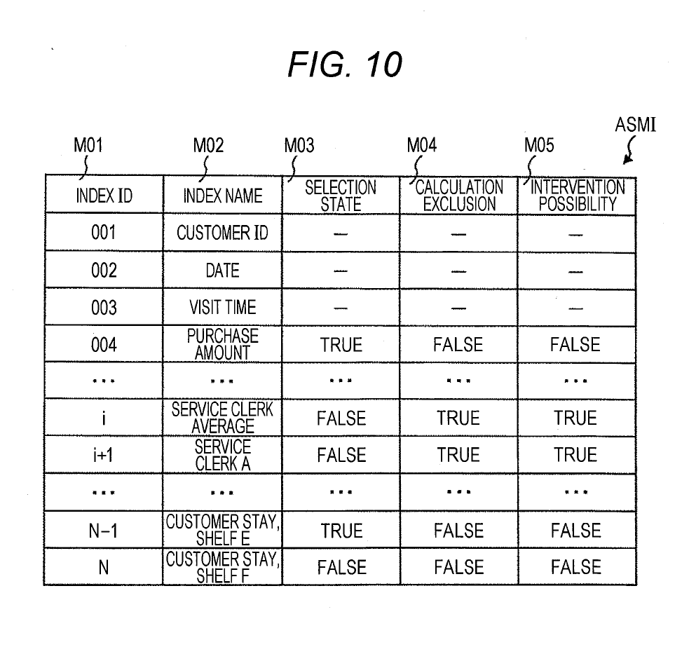

FIG. 10 is a diagram illustrating a configuration of the index selection list (ASMI) and a data example. According to index selection or deselection by the user (US), the index selection managing unit (ASCIM) records the selection state in the index selection list (ASMI). Static information such as the index attribute may be held in the index selection list (ASMI) together.

For example, the index selection list (ASMI) includes columns of an index ID (M01), index name (M02), selection state (M03), calculation exclusion (M04) and intervention possibility (M05), and so on. The index ID (M01) denotes the ID to identify each index. The index name (M02) denotes the name to identify each index by the user (US). The selection state (M03) is rewritten in synchronization with step AS15 and shows in which of the selection state and the deselection state the index is now. The calculation exclusion (M04) is not described in FIG. 7 but shows an index which is decided to be unnecessary because the user (US) does not use it for the future calculation and which designates this information through an interface similar to index selection. The intervention possibility (M05) shows the index attribute, and, as illustrated in FIG. 8B, shows whether it is possible to implement a direct measure to increase or decrease the value of the index. The intervention possibility (M05) may be defined beforehand for each index or may be subjectively designated by the user (US) while operating the screen.

### First Embodiment: Summary

As described above, the data analysis support systems according to the first embodiment assumes any of indices used at the time of data analysis to be an objective variable, implements hierarchical clustering and collectively outputs indices belonging to the identical cluster. By this means, it is possible to gradually and effectively select an index that is highly likely to be able to improve an objective index, from many kinds of indices. By this means, it is possible to reduce the time/manpower/cost required to analyze big data.

Moreover, the data analysis support system according to the first embodiment generates a network diagram showing the correlation between clustered indices, and, moreover, classifies each index in the network diagram according to whether each index can be artificially adjusted (intervened in). By this means, it is possible to effectively narrow an index in which it is possible to implement a measure to improve the objective index.

Moreover, when any index is selected on the network diagram, the data analysis support system according to the first embodiment highlights a path from the index to the objective variable on the network. By this means, a data analyst can hypothetically understand the influence of the selected index with respect to the objective variable according to the path on the network.

### Second Embodiment

In the second embodiment of the present invention, a variation example of each configuration described by the first embodiment is described. Other configurations are similar to the first embodiment and therefore different points from the first embodiment are mainly described below.

In FIG. 7 of the first embodiment, it is considered that a new objective variable is set in an input column (15) and clustering is implemented again after the hierarchical clustering unit (ASCC) implements the clustering once. At that time, each index selected in the clustering display area (CDE2) or the selection index list display area (CDE3) before clustering is implemented again, is maintained to be the selection state in the index selection list (ASMI), and the selection state is reflected on each area and maintained to be selected even after the clustering is implemented again. By this means, it is possible to save the user's (US) effort of reselecting each index.

When downloading an index and sampling data from the analysis server (AS), the client (CL) can additionally download and describe the index name (M02) in the table of the download index (CLMD) as a character string showing the column name of the table. The processing to describe the index name (M02) in the table may be implemented in advance before the analysis server (AS) sends data, or may be implemented after the client (CL) downloads the data.

In the screen described in FIG. 7, when the user (US) selects a correlation coefficient between indices, the client (CL) may perform screen display of the scatter chart of each index corresponding to the correlation coefficient. Alternatively, it is possible to perform screen display of the scatter chart of each index and an objective variable. Each scatter chart may be created by the analysis server (AS) or may be created by downloading sampling data from the analysis server (AS) by the client (CL). By this means, in a case where the correlation coefficient between indices is different from the expectation of a data analyst, whether the correlation coefficient is valid can be visually checked by the scatter chart.

When the client (CL) uploads the original index (CLMO) to the analysis server (AS), the ID of each index may be uploaded together with the original index (CLMO) so as to be able to overwrite save an index that overlaps with an index which the index database (ASMD) already holds. The analysis server (AS) assumes the ID to be a key and stores the identical index. Instead of this, overlapping indices in the original index (CLMO) may be able to be stored as another table and the overlapping indices may be associated with each other using the index ID as a key.

The present invention is not limited to the above-mentioned embodiments and includes various variation examples. The above-mentioned embodiments give a detailed explanation to plainly describe the present invention, and are not necessarily limited to what includes all of the above-mentioned configurations. Moreover, part of the configuration of a certain embodiment can be replaced with the configuration of another embodiment. Moreover, the configuration of another embodiment can be added to the configuration of the certain embodiment. Moreover, regarding part of the configuration of each embodiment, another configuration can also be added, deleted or replaced.

Each above-mentioned configuration, function and processing unit, and so on, may be realized by hardware by designing part or all of them with an integrated circuit, for example. Moreover, each above-mentioned configuration and function, and so on, may be realized by software by interpreting and executing a program that realizes each function by a processor. Information such as a program, table and file, and so on, that realize each function can be stored in recording devices such as a memory, a hard disk and an SSD (Solid State Drive), and recording media such as an IC card, an SD card and a DVD.

What is claimed is:

1. A data analysis support system that supports selection of indices used when data is analyzed, comprising:
a clustering unit that assumes any of the indices as an objective variable and implements clustering with respect to other indices;
an index selecting unit that receives an order to select the index subjected to the clustering by the clustering unit and selects the index according to the order; and
an outputting unit that outputs a clustering result in the clustering unit and a selection result in the index selecting unit, wherein
the index selecting unit receives an order to give an instruction to collectively select indices belonging to an identical cluster among the indices subjected to the clustering by the clustering unit, and collectively selects the indices belonging to the identical cluster according to the order, and
the outputting unit collectively outputs the indices which are collectively selected by the index selecting unit and which belong to the identical cluster.

2. The data analysis support system according to claim 1, further comprising an index correlation calculating unit that calculates correlation between the indices subjected to the clustering by the clustering unit,
wherein the index correlation calculating unit outputs network information that describes a network to express the calculated correlation.

3. The data analysis support system according to claim 2, further comprising an intervention possibility list that defines whether the indices are variables that can be artificially adjusted,
wherein the index correlation calculating unit classifies the indices included in the network into an artificially adjustable variable and an artificially non-adjustable variable according to description of the intervention possibility list, describes a classification result in the network information and outputs the network information.

4. The data analysis support system according to claim 3, wherein
the index correlation calculating unit includes the objective variable in the network and outputs the network information, and
when receiving an order to select any of the indices included in the network, the index correlation calculating unit outputs information showing a path from the index designated by the order to the objective variable on the network.

5. The data analysis support system according to claim 1, wherein
the clustering unit implements the clustering by assuming the index having a highest correlation coefficient with the objective variable as a parent index and assuming an index in which a correlation coefficient with the parent index is equal to or greater than a first threshold and a correlation coefficient with the objective variable is equal to or greater than a second threshold among the other indices, as a child index of the parent index, and
the clustering unit implements the clustering again after setting a residual between the objective variable and the parent index as a second objective variable and removing the parent index from an object of the clustering.

6. The data analysis support system according to claim 1, wherein
the clustering unit receives an order to give an instruction to reselect the objective variable after implementing the clustering and perform the clustering of the indices again, and performs reclustering of the indices according to the order, and
the index selecting unit keeps the indices selected before the clustering unit implements the reclustering, in a state where the indices are still selected even after the reclustering.

7. The data analysis support system according to claim 1, further comprising a client that acquires the indices output by the outputting unit, wherein
the outputting unit outputs a name of each of the indices together with the indices, and
the client notifies an order to select the index to the index selecting unit, and, when acquiring the index and the name from the outputting unit, creates and outputs a list that describes the acquired index and name.

8. The data analysis support system according to claim 1, wherein
the clustering unit receives an order to designate a parameter used when implementing the clustering, and
the outputting unit outputs information that can reproduce the parameter, the clustering result and a selection result in the index selecting unit together with the indices.

9. The data analysis support system according to claim 1, wherein the outputting unit outputs at least any of a scatter chart corresponding to a correlation coefficient between the indices in the clustering result and a scatter chart corresponding to a correlation coefficient between the index and the objective variable.

10. The data analysis support system according to claim 1, further comprising a client that acquires the indices output by the outputting unit, wherein
the client returns the indices acquired from the outputting unit to the outputting unit together with an identifier of each of the indices, and
the outputting unit saves each of the indices returned from the client, using the identifier of each of the indices as a key.

11. The data analysis support system according to claim 1, wherein the index selecting unit receives an order to collectively deselect the indices belonging to the identical cluster, and collectively deselects the indices belonging to the identical cluster according to the order.

12. The data analysis support system according to claim 1, wherein the outputting unit outputs sampling data collected according to the indices together with the indices.
